(19) United States
(12) Patent Application Publication
(10) Pub. No.: US 2025/0356783 A1
(43) Pub. Date: Nov. 20, 2025

(54) CONTEXT-BASED USER INPUT CONTROL OF NEAR-EYE DISPLAYS

(71) Applicant: GOOGLE LLC, Mountain View, CA (US)

(72) Inventors: Dongeek Shin, San Jose, CA (US); Tianyu Xu, Mountain View, CA (US)

(21) Appl. No.: 18/669,279

(22) Filed: May 20, 2024

(51) Int. Cl. G09G 3/00; G06F 3/01

(52) U.S. Cl. CPC G09G 3/002; G06F 3/013; G09G 2354/00

(57) ABSTRACT

A near-eye display includes a processor to generate a sensor input value based on sensor data received from one or more sensors associated with the near-eye display and generate a context value based on a contextual score indicating a user state associated with the near-eye display. The contextual score is based in part on previous user interactions with a user interface of the near-eye display. The processor is also configured to compute an input event value based on the sensor input value and the context value and determine whether to trigger a change in virtual content displayed by the near-eye display based on comparing the input event value to a threshold.

### BACKGROUND

Extended Reality (XR) near-eye displays project computer-generated content (also referred to as “virtual content”) to a user through at least one lens of the near-eye display. Some near-eye displays allow for user interaction via a user interface (UI) to trigger a change in the virtual content that is projected to the user. For example, the UI of the near-eye display may be configured to track different user motions (e.g., hand gestures, head movements, or the like) via one or more sensors at the near-eye display or at another device (e.g., such as a mobile phone or a smartwatch) that is paired with the near-eye display. In some cases, the user motions or gestures may result in interactions with the virtual content, and in other cases, the user motions may be tied to specific commands of the near-eye display's UI independent of the virtual content.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of a near-eye display in accordance with some embodiments.

FIG. 2 shows an example of light propagation from an image source to a user of a near-eye display, such as the near-eye display of FIG. 1, in accordance with some embodiments.

FIG. 3 shows an example of a user perspective when looking through a near-eye display such as the near-eye display of FIGS. 1 and 2 in accordance with some embodiments.

FIG. 4 shows an example of a near-eye display communicating with one or more paired devices in accordance with some embodiments.

FIG. 5 shows an example of the near eye display generating an input event value based on sensor data and a contextual score in accordance with some embodiments.

FIG. 6 shows an example of a user input architecture for a near-eye display such as one illustrated in the previous figures, in accordance with some embodiments.

FIG. 7 shows an example of a flowchart illustrating a user input method that employs a combination of sensor data and UI contextual information to identify user input events in accordance with some embodiments.

### DETAILED DESCRIPTION

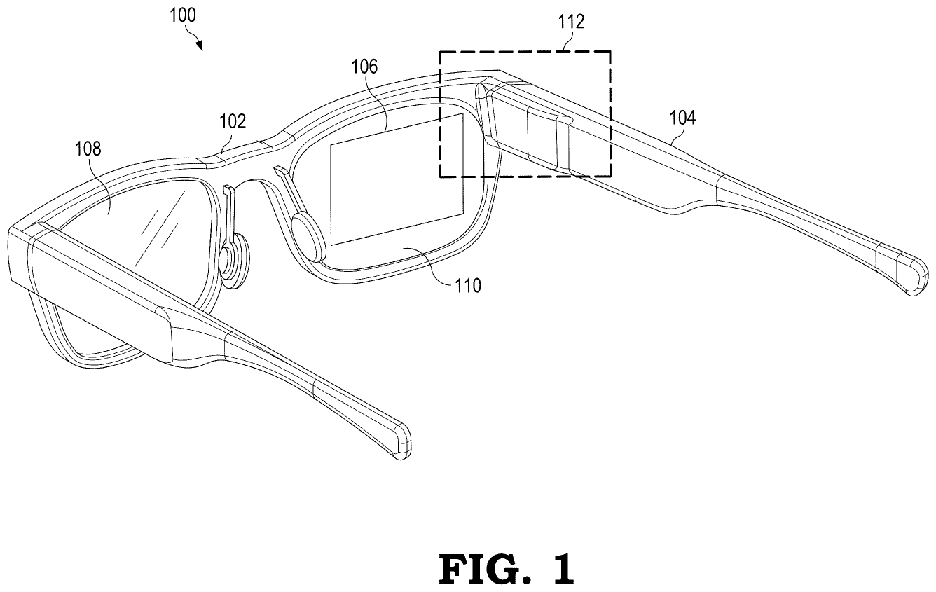

Near-eye displays employ various types of sensors such as cameras, microphones, internal measurements units (IMUs) (e.g., accelerometers, gyroscopes, or the like), biometric sensors, and eye-gaze detection systems to detect user input events that allow the user to interact with displayed virtual content, with a user interface (UI), or both. The detection of these user input events relies on the ability of the UI of the near-eye display to accurately identify user actions (e.g., hand gestures, eye movements, head movements, voice commands, or the like) that trigger a particular corresponding action. For instance, in some cases, a near-eye display may display an icon of a virtual menu at the bottom of the user's field of view (FOV), and the user may open the menu by pointing to a location that the icon occupies within the FOV with their finger, by staring at the location that the icon occupies within the FOV for a certain duration of time, or by issuing a voice command. However, these user input events are more difficult to accurately identify relative to conventional input methods such as typing on a keyboard, pointing and clicking with a mouse, or touching a touchscreen. For example, the user may use similar hand movements for a real-world task and near-eye display UI task, and conventional near-eye displays may struggle to distinguish the real-world task from the near-eye display UI task. Similarly, the user may use similar words when issuing a voice command and when having a conversation with another person. FIGS. 1-7 provide devices and techniques that implement a user input framework that supplements sensor input data with custom trained UI contextual data to generate a user input score to determine whether or not to trigger a user input event. By utilizing the sensor input data along with the trained UI contextual data, the accuracy of input detection by the near-eye display is increased, thereby improving user experience.

To illustrate, in some embodiments, a near-eye display implements a user input detection method that includes the near-eye display generating a value, referred to herein as a sensor input value, based on sensor data received from one or more sensors associated with the near-eye display. The one or more sensors are, for example, located at the near-eye display and include one or more of a camera, a microphone, an IMU, a biometric sensor, an eye-gaze detection system, or the like. In addition or in the alternative, one or more sensors are located at another device (e.g., a mobile phone or a smartwatch) that is paired with the near-eye display via a wireless communication link such as a Bluetooth™ link. The user input detection method also includes the near-eye display generating another value, referred to herein as a context value, based on a contextual score indicating a user state associated with the near-eye display, where the contextual score is at least in part based on a history of previous user interactions. For example, in some embodiments, the near-eye display employs a transformer encoder-decoder to generate the context value based on a data distribution of historical user interactions (e.g., user gestures). The user input detection method further includes the near-eye display computing an input event value from the sensor input value and the context value. Finally, the user input detection method includes the near-eye display determining whether to trigger a change in the virtual content displayed to the user based on the input event value. For example, the near-eye display triggers a change in the virtual content displayed to the user based on the input event value meeting or exceeding a threshold.

In some embodiments, any of the elements, components, or blocks shown in the ensuing figures are implemented as one of software executing on a processor, hardware that is hard-wired (e.g., circuitry) to perform the various operations described herein, or a combination thereof. For example, one or more of the described blocks or components (e.g., blocks or components associated with the user input detection techniques described herein) represent software instructions that are executed by hardware such as a digital signal processor, an application-specific integrated circuit (ASIC), a set of logic gates, a field programmable gate array (FPGA), programmable logic device (PLD), a hardware accelerator, a parallel processor, neural network (NN) or artificial intelligence (AI) accelerator, or other type of hardcoded or programmable circuit.

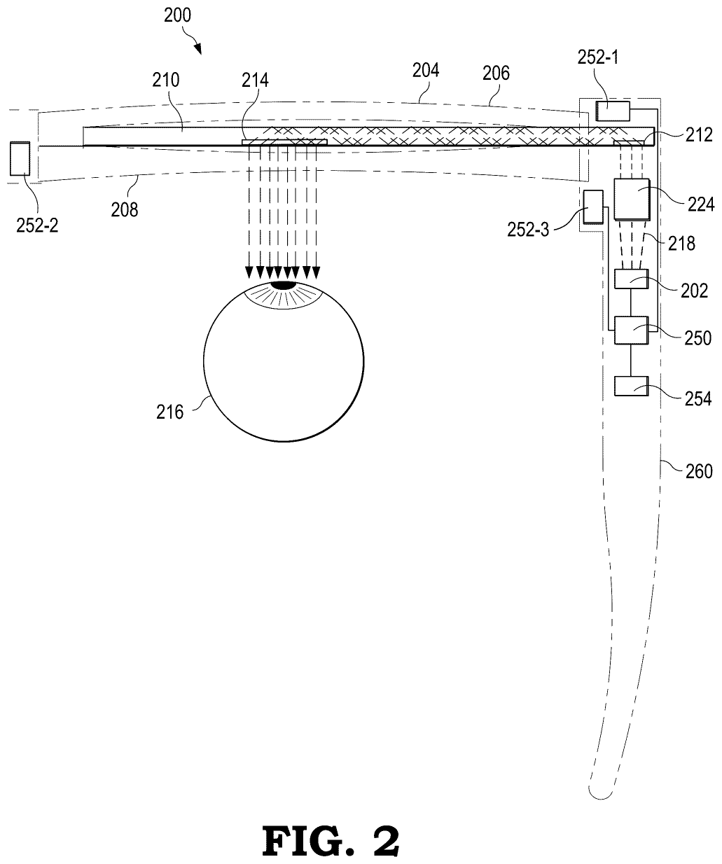

FIG. 1 illustrates an example near-eye display 100 in accordance with various embodiments. The near-eye display 100 (also referred to as a wearable heads up display (WHUD), head-mounted display (HMD), eyewear display, or the like) has a support structure 102 that includes an arm 104, which houses a micro-display projection system configured to project virtual content (e.g., virtual images) toward the eye of a user, such that the user perceives the projected images as being displayed in a field of view (FOV) 106 of a display at one or both of lens elements 108, 110. For example, in some embodiments, the near-eye display 100 is an extended reality (ER) near-eye display such as an augmented reality (AR) near-eye display, a mixed reality (MR) near-eye display, or a virtual reality (VR) near-eye display. In the depicted embodiment, the support structure 102 of the near-eye display 100 is configured to be worn on the head of a user and has a general shape and appearance (i.e., “form factor”) of an eyeglasses frame. The support structure 102 contains or otherwise includes various components to facilitate the projection of such images towards the eye of the user, such as an image source, a light engine assembly (LEA) including one or more lenses, prisms, mirrors, or other optical components, and a waveguide (shown in FIG. 2, for example). In some embodiments, the support structure 102 further includes various sensors, such as one or more front-facing cameras, rear-facing cameras, other light sensors, IMUs, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the near-eye display 100. In some embodiments, some or all of these components of the near-eye display 100 are fully or partially contained within an inner volume of support structure 102, such as within the arm 104 in region 112 of the support structure 102. It should be noted that while an example form factor is depicted, it will be appreciated that in other embodiments the near-eye display 100 may have a different shape and appearance from the eyeglasses frame depicted in FIG. 1.

In some embodiments, one or both of the lens elements 108, 110 are used by the near-eye display 100 to provide a mixed reality (MR) or an augmented reality (AR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the near-eye display 100 and light emitted from an image source in the near-eye display 100. For example, light used to form a perceptible image or series of images may be projected by the image source of the near-eye display 100 onto the eye of the user via a series of optical elements, such as a waveguide formed at least partially in the corresponding lens element, a LEA including one or more light filters, lenses, scan mirrors, optical relays, prisms, or the like, and a patterned layer formed on the front surface of the image source. In some embodiments, the image source is controlled by a controller or processor and is configured to emit light having a plurality of wavelength ranges, e.g., red light, green light, and blue light (collectively referred to as RGB light) to an LEA, and the LEA propagates the light towards an incoupler of the waveguide. The incoupler of the waveguide receives this light and incouples it into the waveguide. One or both of the lens elements 108, 110 thus includes at least a portion of a waveguide that routes display light received by the incoupler of the waveguide to an outcoupler of the waveguide, which outputs the display light towards an eye of a user of the near-eye display 100. The display light is modulated and projected onto the eye of the user such that the user perceives the display light as an image in the FOV 106. In addition, in some embodiments, each of the lens elements 108, 110 is sufficiently transparent to allow a user to see through the lens elements to provide a field of view of the user's real-world environment such that the image appears superimposed over at least a portion of the real-world environment.

In some embodiments, the image source is a modulative light source such as laser projector or a display panel having one or more light-emitting diodes (LEDs) or organic light-emitting diodes (OLEDs) (e.g., a micro-LED display panel or the like) located in the region 112. In some embodiments, the image source is configured to emit RGB light. The image source is communicatively coupled to the controller (not shown) and a non-transitory processor-readable storage medium or memory storing processor-executable instructions and other data that, when executed by the controller, cause the controller to control the operation of the image source. In some embodiments, the controller controls a display area size and display area location for the image source and is communicatively coupled to the image source that generates virtual content to be displayed at the near-eye display 100. In some embodiments, the image source emits light over a variable area, designated the FOV 106, of the near-eye display 100. The variable area corresponds to the size of the FOV 106, and the variable area location corresponds to a region of one of the lens elements 108, 110 at which the FOV 106 is visible to the user. Generally, it is desirable for a display to have a wide FOV 106 to accommodate the outcoupling of light across a wide range of angles.

As previously mentioned, the near-eye display 100 employs a user interface (UI) that allows the user to modify or control the virtual images (also referred to as “computer-generated content” or “virtual content”) that is displayed to the user by the image source. As such, the near-eye display 100 is equipped with various sensors (e.g., cameras, microphones, internal measurements units (IMUs) (e.g., accelerometers, gyroscopes, or the like), biometric sensors, and eye-gaze detection systems) that track user input to generate sensor data. The near-eye display 100 includes a processor or controller that generates a sensor input value based on the sensor data. In addition, the processor or controller employs a transformer encoder-decoder or other type of machine learning model to generate a context value based on a data distribution of historical user interactions. The processor or controller then generates an input event value based on the sensor input and context values and compares the input event value to a threshold value to determine whether a user input event has occurred. If the processor or controller determines that a user input event has occurred, the processor or controller sends a control signal to the image source to modify emission of light from the image source or to a speaker to generate a particular sound.

FIG. 2 shows a portion of a near-eye display 200 in accordance with various embodiments. In some embodiments, the portion of the near-eye display 200 represents a portion of the near-eye display 100 of FIG. 1.

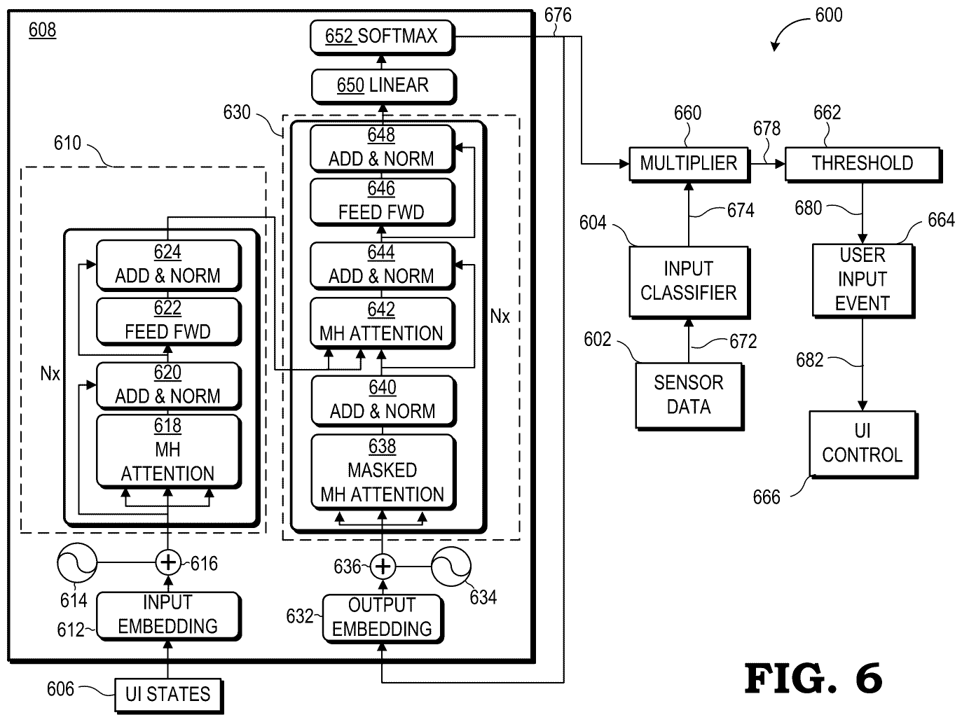

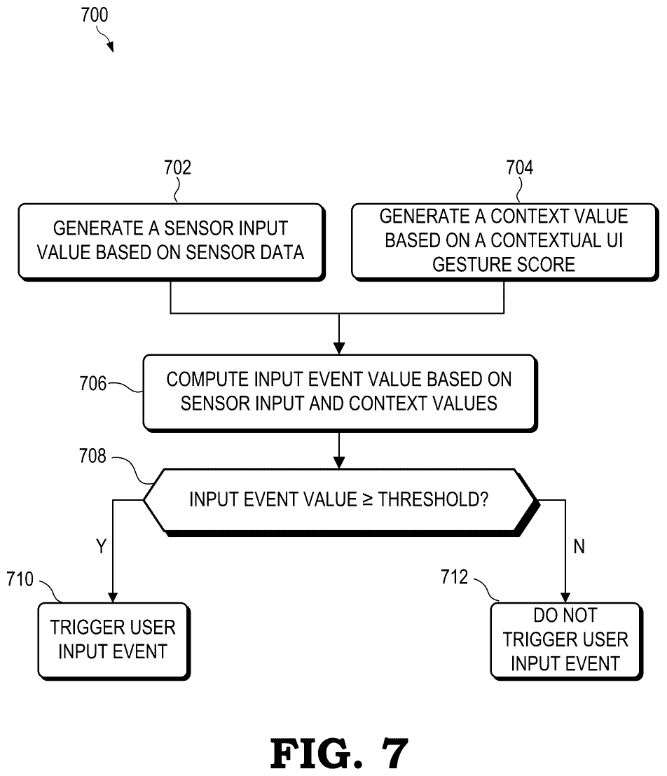

In the illustrated embodiment, the near-eye display 200 includes an arm 260 which houses one or more of an image source 202, one or more sensors 252, a near-eye display processor 250, and a communication interface 254. Although depicted as being in the arm 260 of the near-eye display 200 in the illustrated embodiment, in other embodiments, one or more of the aforementioned components are positioned elsewhere in the near-eye display 200. The one or more sensors 252 includes at least one of a camera, another type of image sensor, a microphone, an IMU (e.g., an accelerometer, a gyroscope, or the like), a biometric sensor, or an eye-gaze detection sensor of an eye tracking system. For example, in the illustrated embodiment, the one or more of the sensors 252 include a first camera 252-1 that is a front-facing camera (e.g., facing the world-side of the near-eye display 200) near a temple region of the near-eye display 200, a second camera 252-2 in the nose bridge region facing the user that is part of an eye-gaze tracking system of the near-eye display 200, and an IMU 252-3 such as an accelerometer or gyroscope that is used to track movements of the near-eye display 200. In some embodiments, each one of the one or more sensors 252 is configured to generate sensor data and provide the sensor data to the processor 250. For example, the first camera 252-1 and second camera 252-2 generate image data and provide the image data to the processor 250, and the IMU 252-3 generates specific force data, angular rate data, and/or orientation data and provides the corresponding data to the processor 250. As such, the one or more sensors 252 include a communication interface and corresponding communication link with the processor 250. In some embodiments, the processor 250 may include one or more processing circuits or units such as a central processing unit (CPU), a graphics processing unit (GPU), a neural network (NN) accelerator, a parallel processor, or other type of hardware or circuitry configured to perform the techniques described herein. In some embodiments, the processor 250 is coupled to or includes a memory (not shown for clarity purposes) storing instructions thereon to manipulate the processor 250 to perform the techniques recited herein. For example, the processor 250 includes a combination of hardware and/or software to implement the user input architecture of FIG. 6 and to perform the method of FIG. 7.

Furthermore, in the illustrated embodiment, the near-eye display 200 includes a communication interface 254 that allows the near-eye display 200 to communicate with other devices. For example, in some embodiments, the communication interface 254 includes one or more of a RF interfaces or other wireless interfaces, such as a Bluetooth™ interface, a WiFi interface, and the like. In some cases, the communication interface 254 enables the near-eye display 200 to communicate with another proximate device that is paired with the near-eye display such as a mobile phone or a smartwatch via shorter range communications such as Bluetooth™ or Near Field Communication (NFC). In other cases, the communication interface 254 allows the near-eye display 200 to communicate with other more distant devices via a network such as a wireless local area network (WLAN) or via a Third Generation Partnership Project (3GPP) cellular network such as a Fifth Generation (5G) network. As such, the communication interface 254 includes one or more of a transceiver, a modem, an antenna, and other RF communication circuitry configured to transmit and receive RF signals over different frequencies and according to different communication standards.

The near-eye display 200 includes an optical combiner lens 204, which includes a first lens 206, a second lens 208, and a waveguide 210 disposed between the first lens 306 and the second lens 308. The waveguide 210 includes an incoupler 212 that is configured to incouple display light emitted from the image source 202 through a light engine assembly (LEA) 224. In some embodiments, the LEA 224 includes optical components such as one or more mirrors, lenses, filters, prisms, or other optical components for shaping and directing the light from the image source 202 to the incoupler 212 of the waveguide 210. After being incoupled to the waveguide 210, light travels through the waveguide 210 through one or more instances of total internal reflection (TIR) at the waveguide 210 surfaces toward an outcoupler 214 of the waveguide. Light exiting through the outcoupler 214 travels through the second lens 208 (which corresponds to, for example, part of the lens element 110 of the near-eye display 100). In use, the light exiting second lens 208 enters the pupil of an eye 216 of a user wearing the near-eye display 200, causing the user to perceive a displayed image carried by the display light output by the image source 202. In some embodiments, the optical combiner lens 204 is substantially transparent, such that light from real-world scenes corresponding to the environment around the near-eye display 200 passes through the first lens 206, the second lens 208, and the waveguide 210 to the eye 216 of the user. In this way, images or other graphical content output by the image projection system of the near-eye display 200 are combined (e.g., overlayed) with real-world images of the user's environment when projected onto the eye 216 of the user to provide an AR experience to the user. In some embodiments additional optical elements are included in any of the optical paths between the image source 202 and the incoupler 212, in between the incoupler 212 and the outcoupler 214, and/or in between the outcoupler 214 and the eye 216 of the user (e.g., in order to shape the display light from image source 202 for viewing by the eye 216 of the user).

As illustrated in FIG. 2, the waveguide 210 of near-eye display 200 includes the incoupler 212 and the outcoupler 214. In some embodiments, the waveguide also includes an exit pupil expander positioned in the optical path between the incoupler 212 and the outcoupler 214 (not shown in FIG. 2 for clarity purposes). The term “waveguide,” as used herein, will be understood to mean a combiner using one or more of total internal reflection (TIR), specialized filters, or reflective surfaces, to transfer light from an incoupler (such as incoupler 212) to an outcoupler (such as the outcoupler 214). In some display applications, the light is a collimated image, and the waveguide 210 transfers and replicates the collimated image to the eye. In general, the terms “incoupler,” “exit pupil expander,” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler, exit pupil expander, or outcoupler is configured as a transmissive grating (e.g., a transmissive diffraction grating or a transmissive holographic grating) that causes the incoupler, exit pupil expander, or outcoupler to transmit light and to apply designed optical function(s) to the light during the transmission. In some embodiments, a given incoupler, exit pupil expander, or outcoupler is a reflective grating (e.g., a reflective diffraction grating or a reflective holographic grating) that causes the incoupler, exit pupil expander, or outcoupler to reflect light and to apply designed optical function(s) to the light during the reflection.

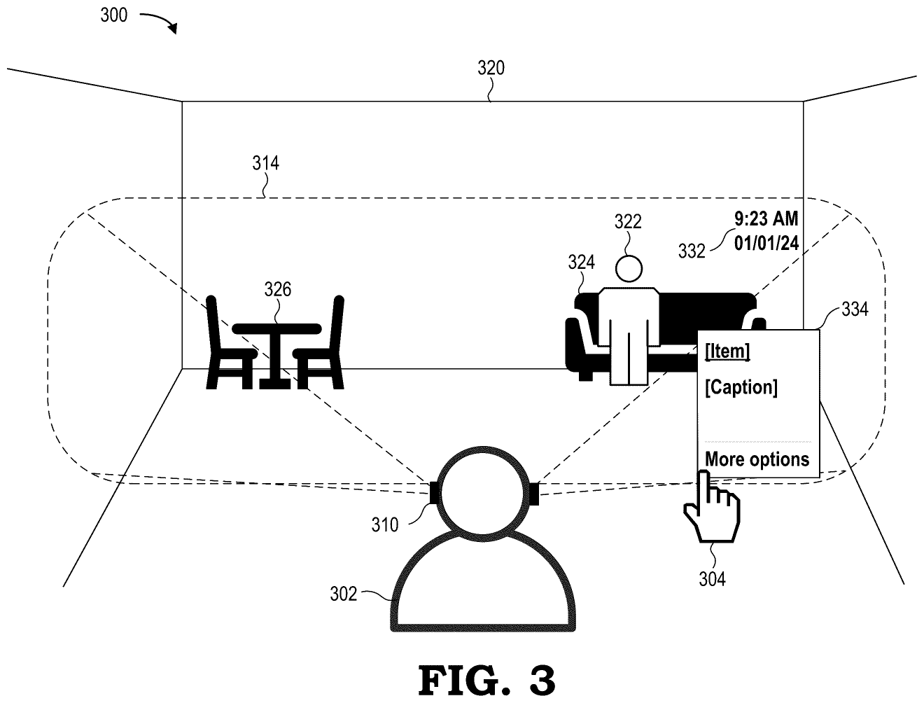

FIG. 3 illustrates an example view 300 of a user 302 wearing a near-eye display 310 in accordance with some embodiments. In the illustrated embodiment, the user 302 is wearing the near-eye display 310, which may correspond to the near-eye display of FIGS. 1 and 2, and facing out toward a room 320 (i.e., the back of the user's 302 head is illustrated in FIG. 3). The room 320 has another person 322 sitting on a couch 324 to the right of the user 302 and a dining set 326 including a table and two chairs to the left of the user 302. In addition, FIG. 3 shows an example outline of a FOV 314 within which the user 302 can observe virtual content that is produced by the image projection system (e.g., including an image source, LEA, and waveguide such as the image source 202, LEA 224, and waveguide 210, respectively, of FIG. 2) in the near-eye display 310. In the illustrated embodiment, one such example of virtual content is an interactive menu 334, which is shown as being opaque and being positioned over the couch 324 so as to block out a section of the couch 324 from the user's 302 perspective. In alternative embodiments, the near-eye display 310 is configured to generate semi-transparent virtual content (e.g., the interactive menu 334) so as to allow the user 302 to perceive the real-world (e.g., the couch 324) through the virtual content. As such, the near-eye display 310 allows the user 302 to observe the real-world (e.g., the room 320 with the person 322 sitting on the couch 326 and the dining set 328) along with virtual content (e.g., the date and time 332 and the interactive menu 334) that is generated by the near-eye display 310.

Similar to the near-eye display of FIGS. 1 and 2, the near-eye display 310 includes sensors (e.g., one or more inward facing cameras for eye-gaze tracking, one or more outward facing cameras for hand gesture recognition, IMUs for head movement detection, a microphone to receive voice commands, and the like) that provide a user interface for the user 302 to control the virtual content that is displayed by the near-eye display 310. For example, in the illustrated embodiment, an outward facing camera of the near-eye display 310 tracks the user's hand 304 gestures and identifies when the hand 304 is pointing to an item in the interactive menu 334. In alternative embodiments, an inward facing camera (i.e., facing the user 302) of the near-eye display 310 tracks the user's 302 gaze and identifies when an eye of the user 302 focuses on an item in the interactive menu 334 for a particular duration of time. In either case, a processor of the near-eye display 302 utilizes the generated sensor data (e.g., the sensor data generated by the outward facing camera tracking the hand 304 or the sensor data generated by the inward facing camera tracking the gaze of the user 302) to determine whether a user input event has occurred in order to trigger a change in the virtual content displayed by the near-eye display 310 to the user 302.

In the illustrated embodiment, two examples of virtual content are depicted: the time and date 332 in the upper right hand corner of the FOV 314 and the interactive menu 334 in the bottom right hand corner of the FOV 314. In other embodiments, the near-eye display 310 is configured to generate other types of virtual content (e.g., virtual objects or images, text, or the like) that the user 302 can perceive within the FOV 314. In some embodiments, the near-eye display 310 is configured to track the user's hand 304 gestures (e.g., by employing one or more outward facing cameras such as first camera 252-1 of FIG. 2 and a processor such as processor 250 of FIG. 2 configured to perform hand gesture recognition based on image data captured by the outward facing cameras) to allow the user 302 to interact with the interactive menu 334. For example, in the illustrated embodiment, the user 302 is pointing the index finger of their hand 304 to the “More options” item in the interactive menu 334. The near-eye display 310 is configured to detect the hand 304 pointing to a position associated with the “More options” item in the interactive menu 334 and trigger the near-eye display 310 to modify the virtual content, e.g., by opening up another interactive menu with additional options.

In some scenarios, the user 302 may make motions or gestures in the form of interactions with the virtual content (e.g., the user 302 may make hand gestures to interact with the interactive menu 334) or may make motions or gestures that are tied to specific commands of the near-eye display's 310 UI independent of the virtual content (e.g., the user 302 may make a head movement or a hand movement that triggers a certain action such as opening an application or a notification irrespective of the virtual content displayed at the near-eye display 310). In addition, the user 302 may make motions or gestures to interact with the real-world environment (e.g., pointing to the other person 322 or picking up an object from the table in the dining set 326). As such, the processing system (e.g., including a processor such as processor 250 of FIG. 2) of the near-eye display 310 is configured to implement a user input framework that utilizes multiple factors to determine whether a user input event has occurred in order to trigger a change in the virtual content displayed to the user 302.

For example, in some embodiments, a first factor of the user input framework implemented by the processing system of the near-eye display 302 includes sensor data that is generated by one or more sensors of the near-eye display 302. In other embodiments, one or more sensors at another device (such as a mobile phone or smartwatch, not shown in FIG. 3) that is paired with the near-eye display 302 provides additional sensor data that the near-eye display 302 uses to generate the sensor data. In addition, and different from conventional near-eye displays that solely rely on sensor data, the user input framework implemented by the processing system of the near-eye display 302 also utilizes a second factor that includes custom trained UI transition data. The custom trained UI transition data, in some embodiments, is based on a given UI state and a user context. As such, in addition to tracking the user's gestures (e.g., hand movements, gaze, head movements, and the like) to generate a sensor input value, the near-eye display 310 also generates a context value that is based on a given user UI state and context for when the sensor data value is obtained. In some embodiments, the near-eye display 310 employs a transformer encoder-decoder that is custom trained on UI transition data and sensor data to extrapolate the context value given the user UI state and the context based on a history of previous user interactions. In some embodiments, a processor of the near-eye display 310 stores the history of previous user interactions at a memory of the near-eye display. The history of previous user interactions, in some cases, includes information related to received user input commands to trigger a particular action by the near-eye display (e.g., change in the virtual content provided to the user). Furthermore, the user input framework implemented by the processing system of the near-eye display 310 generates an input event value based on the sensor input value and the context value corresponding to the UI state and user context. Then, the processing system of the near-eye display 310 compares the input event value to a threshold. If the input event value meets or exceeds the threshold, the processing system of the near-eye display 310 determines that a user input event has occurred and triggers a change in the virtual content displayed to the user. If the input event value does not meet the threshold, the processing system of the near-eye display 310 determines that a user input event has not occurred. By implementing a user input framework in this manner, the processing system of the near-eye display 310 provides a higher-accuracy UI than simply relying on live sensor observations alone.

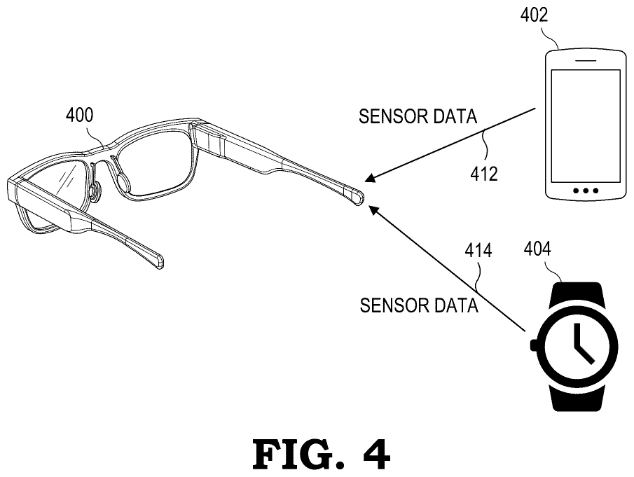

FIG. 4 shows an example of a near-eye display 400 communicating with devices 402, 404 in accordance with some embodiments. The near-eye display 400, for example, corresponds to any one of the near-eye displays of FIGS. 1, 2, and 3. In the illustrated embodiment, the first device 402 is a smartphone, and the second device 404 is a smartwatch. In other embodiments, one or more of the devices 402, 404 can be another type of device such as a set of headphones or another type of wearable device (e.g., a ring).

In the illustrated embodiment, the near-eye display 400 establishes a first communication link 412 with the smartphone 402 and a second communication link 414 with the smartwatch 404. In some embodiments, each one of the communication links 412, 414 is a RF link such as a Bluetooth™ link or other type of RF link. As such, each one of the near-eye display 400, smartphone 402, and the smartwatch 404 is equipped with one or more of a transceiver, a modem, an antenna, and other RF communication circuitry configured to transmit and receive RF signals with each other. For example, each one of the smartphone 402 and smartwatch 404 generates sensor data based on its corresponding sensors and communicates the sensor data to the near-eye display over the respective communication links 412, 414.

In some embodiments, the smartphone 402 is equipped with various sensors such as one or more cameras, one or more microphones, one or more internal measurements units (IMUs) (e.g., accelerometers, gyroscopes, or the like), one or more biometric sensors, and the like. In some embodiments, the sensors of the smartphone 402 are different or more sophisticated than the sensors of the near-eye display 400. For example, the smartphone 402 may be equipped with a camera having a higher resolution than that of the near-eye display. Additionally or alternatively, the sensors of the smartphone 402 provide a different perspective than the corresponding sensors of the near-eye display 400. For example, the camera of the smartphone 402 can provide a different perspective of the user's hand than the near-eye display 400 and thus be able to provide additional, or in some cases more accurate, sensor data that the near-eye display 400 can utilize for gesture recognition. The smartwatch 404 is also equipped with one or more sensors such as one or more cameras, one or more microphones, one or more internal measurements units (IMUs) (e.g., accelerometers, gyroscopes, or the like), one or more biometric sensors, and the like. In some embodiments, the smartwatch 404 provides additional sensor data that more accurately tracks the motion of the user's hand compared to that of the near-eye display 400 by virtue of the smartwatch 404 being on the wrist of the user. As such, each one of the devices 402, 404 generates additional sensor data that the near-eye display 400 utilizes in the user input framework to increase the accuracy of its UI.

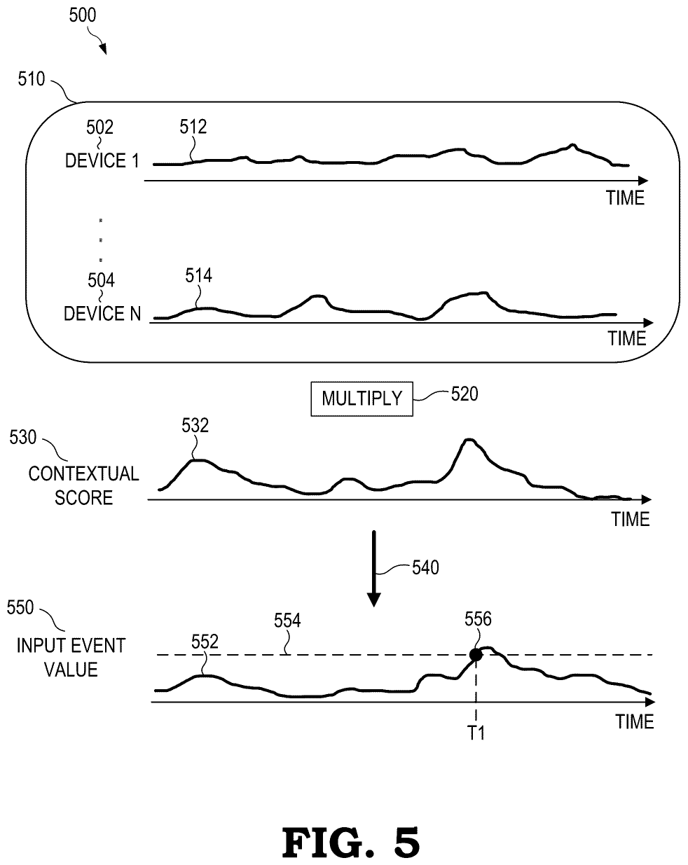

FIG. 5 shows an example diagram 500 illustrating the computation of an input event value from a sensor input value based on sensor data and a context value based on a contextual score in accordance with some embodiments. In some embodiments, a processor or processing system (e.g., the processor 250 of FIG. 2) of a near-eye display (e.g., the near-eye displays of FIGS. 1-4) is configured to compute the input event value. The terms “input event value” and “first value” may be used interchangeably within this disclosure.

In the illustrated embodiment, the box 510 represents the generation of the sensor input value based on sensor data from one or more devices. For example, the first device (Device 1) 502 represents a near-eye display such as near-eye display 100 of FIG. 1, near-eye display 200 of FIG. 2, near-eye display 310 of FIG. 3, or near-eye display 400 of FIG. 4. The first device 502 generates sensor data based on one or more of its sensors to generate a sensor data value signal over time represented by line 512. One or more additional devices (Device N) 504 also generates sensor data based on one or more of its sensors to generate a sensor data value signal over time represented by line 514. The one or more additional devices 504, for example, may be a smartphone such as smartphone 402 of FIG. 4 or a wearable device such as smartwatch 404 of FIG. 4. The near-eye display then computes a combined sensor data value based on sensor data value signals 512, 514. For example, in some embodiments, the processor of the near-eye display is configured to compute a running average of the sensor data value signals 512, 514. In some embodiments, one of the sensor data value signals 512, 514 is assigned a heavier weight or contribution to the combined sensor data value. For example, the sensor data value signal 512 of the first device 502 is assigned a higher relative weight than the sensor data value signal 514 of the second device 504 when computing the combined sensor data value of the devices 502, 504. The combined sensor data value of the devices 502, 504 is then used to generate the sensor input value based on the sensor data.

Diagram 500 also illustrate the contextual score 530 that provides a contextual data value signal over time that is represented by line 532. That is, the processor of the near-eye display generates the contextual data value signal 532 which represents a contextual and UI state value. In some embodiments, the processor of the near-eye display employs a custom language model to generate the contextual data value signal 532 in real-time from a prior distribution of user interactions with the UI of the near-eye display given certain options at a different points in time.

The processor of the near-eye display is then configured to compute an input event value 550 based on the sensor input value from the sensor data 510 and the context value from the contextual score 530. For example, in the illustrated embodiment, the processor of the near-eye display multiplies 520 the sensor input value obtained from the sensor data value signals 512, 514 of the sensor data 510 with the context value obtained from the context data value signal 532 of the contextual score 530 to generate 540 an input event value signal 552. In some embodiments, the processor is configured to assign a first weight to the sensor input value from the sensor data 510 and assign a second weight to the context value 530 when computing the input event value signal 552. In some embodiments, the first weight and the second weight are fixed, and in other embodiments, the first weight and the second weight are dynamically adjusted by the processor based on collecting UI accuracy data over a period of time. In any event, multiplying the combined sensor data value based on sensor data value signals 512, 514 with the contextual value signal 532 generates an input event value signal 552 in real-time. In some embodiments, rather than multiplying the sensor input value and the context value as illustrated in the embodiment shown in FIG. 5, the processor is configured to add the sensor input value obtained from the sensor data value signals 512, 514 of the sensor data 510 with the context value obtained from the context data value signal 532 of the contextual score 530 to generate 540 the input event value signal 552.

In some embodiments, the processor of the near-eye display compares the generated input event value generated over time (i.e., input event value signal 552) with a threshold value represented by dashed line 554. If the input event value 552 is below the threshold value 554, then the processor of the near-eye display does not detect a user input event and does not trigger an action at the near-eye display (e.g., a modification in the virtual content displayed to the user, a sound generated by a speaker of the near-eye display, or the like). At time T1 556, the input event value 552 meets or exceeds the threshold value 554. This triggers the near-eye display to detect a user input event and thus trigger an action such as modifying the virtual content displayed to the user. Thus, by generating an input event value based on sensor data and contextual data, the near-eye display is able to more accurately detect when a user input event has occurred compared to relying on sensor data alone.

FIG. 6 shows an example of a user input architecture 600 implemented by a processor in a near-eye display (such as by the processor 250 in near-eye display 200 of FIG. 2) to determine user input events at a UI of the near-eye display in accordance with some embodiments. The user input architecture 600 is configured to receive two inputs (the sensor data 602 and the UI states 606) and output a UI control signal 666 based on whether the two inputs are determined to trigger a user input event at a UI of the near-eye display. In some embodiments, aspects of the user input architecture 600 are implemented via hardware, software, or a combination thereof. For example, in some embodiments, the transformer encoder-decoder 608 is implemented as a software module executing on one or more parallel processors such as a graphics processing unit (GPU), a neural network (NN) accelerator, an artificial intelligence (AI) accelerator, or the like.

The user input architecture 600 is configured to receive sensor data 602 as a first input. In some embodiments, the sensor data 602 is received from a dedicated sensor processor or by the sensors themselves. For example, prior to transmitting the sensor data 602 to the user input architecture 600, the dedicated sensor processor normalizes and vectorizes the sensor data from one or more sensors to generate the sensor data 602. In some embodiments, the sensor data 602 is generated based on observations made by one or more sensors at the near-eye display. Additionally, in some embodiments, the sensor data 602 also includes sensor data obtained from one or more additional devices (e.g., a smartphone or a wearable device such as a smartwatch) that is paired with the near-eye display. The sensor data 602 is input 672 to an input classifier 604, which generates sensor data signals from the sensor data. For example, the output 674 of the input classifier 604 corresponds to the sensor data value signals 512, 514 of FIG. 5. That is, the output 674 of the input classifier 604 is a sensor input value that is input to a multiplier 660. Thus, the user input architecture 600 has a first branch, including components 602 and 604, that generates the sensor input value based on the sensor data.

In addition, the user input architecture 600 includes a second branch that is parallel to the first branch described above. The second branch includes a transformer encoder-decoder 608 to generate a contextual UI gesture score 676. The transformer encoder-decoder 608 includes an encoder 610 and a decoder 630. The transformer encoder-decoder 608 outputs the contextual UI gesture score 676 to the multiplier 660. By including the contextual UI gesture score 676 along with the sensor data (i.e., output 674 from the input classifier 604), the user input architecture 600 is able to generate a contextual based sensor score that improves the UI accuracy of the near-eye display. In the illustrated embodiment, a multiplier 660 is used to combine the sensor input value 674 and the contextual UI gesture score 676. In other embodiments, the user input architecture 600 includes another type of combiner, e.g., an adder.

In some embodiments, the transformer encoder-decoder 608 is a neural network (NN) based or artificial intelligence (AI) based contextual UI score model. For example, the transformer encoder-decoder 608 is configured to generate a contextual UI gesture score 676 based in part on a historical distribution of UI states 606 and previous iterations of the contextual UI gesture score 676. The transformer encoder-decoder 608 uses an encoder-decoder architecture in which the encoder extracts features from the historical distribution of UI states 606, and the decoder 630 uses the extracted features along with the previous iterations of the contextual UI gesture score 676 to generate an updated contextual UI gesture score 676. That is, the inputs to the transformer encoder-decoder 608 include the UI states 606 and a previous instance of the contextual UI gesture score 676 that enables the transformer encoder-decoder 608 to compute the updated contextual UI gesture score 676 in an autoregressive manner.

The transformer encoder-decoder 608 receives the UI states 606 from the near-eye display as an external input to the encoder 610. For example, the UI states 606 include a sequence of UI state content (e.g., UI images) obtained from the near-eye display over a particular duration. In some embodiments, the near-eye display (e.g., via the processor such as processor 250 of FIG. 2) obtains the UI state content in response to user gestures or other user input events. In the illustrated embodiment, the encoder 610 includes multiple encoder blocks 618-624. The input to the encoder 610 goes through the multiple encoder blocks 618-624 and the output of the last encoder block 624 is input to the decoder 630. In the illustrated embodiment, the decoder 630 also include multiple decoder blocks 638-648. One or more of the decoder blocks, e.g., the multi-head (MH) attention block 642, is configured to receive features from the encoder 610. In addition, each one of the encoder 610 and the decoder 630 may include multiple instances (Nx) of the blocks illustrated in FIG. 6.

In some embodiments, each one of the UI states 606 input to the encoder 610 of the transformer encoder-decoder 608 is initially converted into an embedding vector indicative of the UI states 606 by the input embedding block 612. In some embodiments, the transformer encoder-decoder 608 learns the embeddings utilized in the embedding block 612 during training of the transformer encoder-decoder 608. In addition, the transformer encoder-decoder 608 includes a combiner 616 to inject a positional encoding 614 into the output of the input embedding block 612 to allow the transformer encoder-decoder 608 to identify relative or absolute position of the elements of the embedding vector output by the input embedding block 612 without recurrence or convolutions. Thus, the input to the encoder 610 of the transformer encoder-decoder 608 includes a sequence of embedding vectors that represent the UI states 606 and their corresponding relative positions obtained from the near-eye display. The encoder 610 employs a self-attention mechanism to process each embedding vector with contextual information from the whole sequence of UI states. Depending on the surrounding UI states, each UI state from the sequence may have more than one potential user input event. Therefore, the self-attention mechanism is implemented via a multi-head (MH) attention block 618 (e.g., X number of parallel attention calculations, where X is a positive integer) so that the transformer encoder-decoder 608 can tap into different embedding subspaces. The encoder 610 includes a position-wise feed-forward network with a first linear layer and a second linear layer which processes each embedding vector independently with similar or identical weights. In this manner, each embedding vector with the contextual information from the MH attention block 618 propagates through the position-wise feed-forward network to the Addition and Normalization (Add & Norm) block 620 for further processing. The encoder 610 also uses residual connections that link an output of one block with a non-consecutive block in the encoder 610. For example, referring to the illustrated embodiment, one residual connection is shown from the output of Add & Norm block 620 to Add & Norm block 624. The residual connections carry over previous embeddings from the originating blocks to the subsequent blocks. As such, the blocks in the encoder 610 supplement (i.e., adds) the processing of the embedding vectors with additional information from the MH attention block 618 and feed forward (Feed Fwd) block 622 of the position-wise feed-forward network in the encoder 610. In the illustrated embodiments, this carrying over of embeddings to subsequent blocks is depicted as the addition component of the Add & Norm blocks 620, 624. In addition, after each residual connection, there is a layer normalization that aims to reduce the effect of covariant shift. In the illustrated embodiment, the layer normalization is depicted as being the normalization component of the Add & Norm blocks 620, 624.

The output of the encoder 610 (i.e., the output of the final Add & Norm block 624) is input to the decoder 630. The decoder 630 includes similar blocks as the encoder 610 such as the Add & Norm blocks 640, 644, 648, the MH attention block 642, and the Feed Forward (Feed Fwd) block 646. In addition to having the output of the encoder 610 as an input at the MH Attention block 642, the decoder 630 feeds back its own output (i.e., the contextual UI gesture score 676) as an input to the output embedding block 632. The input to the output embedding block 632 is shifted (e.g., shifted right) relative to input to the output embedding block 632 of the previous iteration. The output embedding block 632 functions in a comparable manner as the input embedding block 612, and the combiner 636 injects a positional encoding 634 into the output of the output embedding block 632 (similar to the combiner 616 to inject the positional encoding 614 into the output of the input embedding block 612). Accordingly, the decoder 630 operates in a comparable manner as described with respect to the encoder 610 with the exception that the decoder 630 calculates the contextual UI gesture score 676 that is output by the transformer encoder-decoder 608. In addition, the decoder 630 includes a masked multi-head attention (Masked MH Attention) block 638 which processes the position encoded embedding vectors from the combiner 636. The Masked MH Attention block 638 operates in a comparable manner as the MH Attention blocks but receives the inputs with masks to ensure that the attention mechanism of the Masked MH Attention block 638 processes inputs that have been generated up to the current position. Thus, the masking prevents the Masked MH Attention block 638 from “cheating” by looking at future inputs. In addition, as previously mentioned, the decoder 630 inputs the output from the encoder 610 at the MH Attention block 642, which implements a source-target attention that calculates the attention values between the features of the embedding vectors from the input UI states 606 and the features based on the (partial) output generated by the decoder 630. In this manner, the decoder 630 generates an output indicative of a contextual UI score using features from the input and partial output UI states.

The transformer encoder-decoder also includes a linear block 650 that applies a linear transformation to the output vector of the decoder 630 to change the dimension of the output vector from the embedding vector size to a contextual UI score size. The softmax block 652 converts the linearized vector into a contextual UI score 676 (e.g., a context value having a value between 0 and 1) that is the second input to the multiplier 660.

In some embodiments, the context value (i.e., the contextual UI gesture score 676) and the sensor input value (i.e., the output 674 from input classifier 604) input to the multiplier 660 are both gesture scores and have a similar value range, e.g., between 0 and 1. In some embodiments, the context value is generated based on the UI states and previous iterations of the context value, and the sensor input value is generated using live sensor observations. The multiplier 660 of the user input architecture 600 combines (e.g., via multiplication) the two inputs 674, 676 to output an input event value 678 (also referred to herein as a “first value”). In some cases, the input event value 678 represents a Bayesian belief model representative of using live sensor data and prior knowledge of how the user triggers inputs based on the current UI state. The user input architecture 600 also includes a threshold component 662 that compares the input event value to a threshold value stored at the threshold component 662. In some embodiments, the threshold value is set based on offline tuning. Additionally, in some embodiments, the threshold value is a static value, and in other embodiments, the threshold value is dynamically adjusted. For example, the threshold value is dynamically adjusted to further refine the UI of the near-eye display to make it more or less sensitive based on certain user input events. If the input event value 678 meets or exceeds the threshold value of the threshold component 662, the threshold component 662 identifies the occurrence of a user input event 664, which then triggers a UI control signal 666 to generate a UI action at the near-eye display. For example, in some embodiments, the UI action includes generating a control signal to modify the emission of light from an image source such as image source 202 of FIG. 2. In this manner, by augmenting the sensor data with the contextual UI score generated by the transformer encoder-decoder 608, the user input architecture 600 provides a UI of the near-eye display with higher accuracy results.

FIG. 7 shows an example of a flowchart 700 illustrating a user input method for a near-eye display in accordance with some embodiments. In some embodiments, the processor 250 in the near-eye display 200 of FIG. 2 is configured to perform the user input method illustrated in flowchart 700.

At block 702, the method includes the processor of the near-eye display generating a sensor input value based on sensor data (also referred to as a sensor value) as described above with respect to FIGS. 1-6. At block 704, the method includes the processor of the near-eye display generating a context value based on a contextual UI gesture score (also referred to as a contextual score or value) as described above with respect to FIGS. 1-6. At block 706, the method includes the processor of the near-eye display computing an input event value based on the sensor input value (generated at block 702) and the context value (generated at block 704) as described above with respect to FIGS. 1-6. Then, at block 708, the method includes the processor of the near-eye display comparing the input event value to a threshold. If the input event value meets or exceeds the threshold, then at block 710, the processor of the near-eye display triggers a user input event. If the input event value does not meet the threshold, then at block 712, the processor of the near-eye display does not trigger a user input event.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A processor configured to:
generate a sensor input value based on sensor data received from one or more sensors associated with a near-eye display;
generate a context value based on a contextual score indicative of a user state associated with the near-eye display, wherein the contextual score is based in part on previous user interactions with the near-eye display;
compute a first value by combining the sensor input value and the context value; and
trigger a change in virtual content displayed by the near-eye display based on the first value satisfying a threshold.

2. The processor of claim 1, wherein the processor implements a transformer encoder-decoder to generate the context value as an output based on inputs comprising:
a sequence of user interface states of the near-eye display; and
a previous context value generated by the transformer encoder-decoder.

3. The processor of claim 2, wherein the transformer encoder-decoder comprises an encoder to receive the sequence of user interface states and to generate an encoder output, and a decoder to receive the encoder output and the previous context value generated by the transformer encoder-decoder and to generate the context value as the output.

4. The processor of claim 3, wherein the transformer encoder-decoder is trained based on a historical distribution of data indicative of previous user interactions with the near-eye display.

5. The processor of claim 4, wherein the historical distribution of data indicative of the previous user interactions with the near-eye display is at least in part based on a user state, wherein the user state comprises one or more of a user location, a time of day, a user position, or another device communicating with the near-eye display.

6. The processor of claim 1, wherein at least one sensor of the one or more sensors is at the near-eye display.

7. The processor of claim 1, wherein at least one sensor of the one or more sensors is at a second device that is paired with the near-eye display, wherein the second device is a mobile phone or wearable device.

8. The processor of claim 6, wherein the at least one sensor comprises a camera, a microphone, an inertial measurement unit (IMU), a biometric sensor, or an eye-gaze detection system.

9. The processor of claim 1, wherein the sensor input value is within a first range, and the context value is within a second range similar to the first range.

10. The processor of claim 1, wherein the processor applies a corresponding weighted coefficient to at least one of the sensor input value or the context value, wherein the corresponding weighted coefficient is at least in part based on previous user interactions.

11. The processor of claim 1, wherein computing the first value comprises multiplying the sensor input value by the context value.

12. The processor of claim 1, wherein computing the first value comprises adding the sensor input value and the context value.

13. The processor of claim 1, wherein the processor does not trigger the change in the virtual content displayed by the near-eye display based on the first value failing to satisfy the threshold.

14. A near-eye display comprising:
one or more sensors configured to generate sensor data based user gestures; and
a processor configured to:
generate a sensor input value based on the sensor data received from the one or more sensors;
generate a context value based on a contextual score indicative of a user state associated with the near-eye display, wherein the contextual score is based in part on previous user interactions with the near-eye display;
compute a first value by combining the sensor input value and the context value; and
trigger a change in virtual content displayed by the near-eye display based on the first value satisfying a threshold.

15. The near-eye display of claim 14, wherein at least one sensor of the one or more sensors comprises a camera, a microphone, an inertial measurement unit (IMU), a biometric sensor, or an eye-gaze detection system.

16. The near-eye display of claim 14, wherein the processor implements a transformer encoder-decoder to generate the context value as an output based on inputs comprising:
a sequence of user interface states of the near-eye display; and
a previous context value generated by the transformer encoder-decoder,
wherein the transformer encoder-decoder comprises an encoder to receive the sequence of user interface states and to generate an encoder output, and a decoder to receive the encoder output and the previous context value generated by the transformer encoder-decoder and to generate the context value as the output.

17. The near-eye display of claim 16, wherein the transformer encoder-decoder is trained based on a historical distribution of data indicative of previous user interactions with the near-eye display, wherein the historical distribution of data indicative of the previous user interactions with the near-eye display is at least in part based on a user state, wherein the user state comprises one or more of a user location, a time of day, a user position, or another device communicating with the near-eye display.

18. The near-eye display of claim 14, wherein the processor does not trigger the change in the virtual content displayed by the near-eye display based on the first value failing to satisfy the threshold.

19. A method comprising:
generating a sensor input value based on sensor data received from one or more sensors associated with a near-eye display;
generating a context value based on a contextual score indicative of indicating-a user state associated with the near-eye display, wherein the contextual score is based in part on previous user interactions with the near-eye display;
computing a first value by combining the sensor input value and the context value; and
triggering a change in virtual content displayed by the near-eye display based on the first value satisfying a threshold.

20. The method of claim 19, wherein computing the first value comprises multiplying the sensor input value by the context value or adding the sensor input value and the context value.
